(19) United States
(12) Patent Application Publication
(10) Pub. No.: US 2008/0291014 A1
(43) Pub. Date: Nov. 27, 2008

(54) SYSTEM AND METHOD FOR REMOTE DIAGNOSIS AND REPAIR OF A PLANT MALFUNCTION WITH SOFTWARE AGENTS

(75) Inventors: Shunsuke Chigusa, Arlington, MA (US); Danil V. Prokhorov, Canton, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Engineering & Manufacturing North America, Inc., Erlanger, KY (US)

(21) Appl. No.: 11/752,500

(22) Filed: May 23, 2007

(51) Int. Cl. G08B 21/00

(52) U.S. Cl. 340/540

(57) ABSTRACT

A system and method for the remote diagnosis and repair of a plant malfunction in an automotive vehicle. The method includes the step of sending a plant malfunction diagnostic request to the remote station. Thereafter, the remote station transmits a software agent selected as a function of the nature of the malfunction from the remote station and to the vehicle. Upon execution, the software agent collects plant data relevant to the malfunction and transmits that collected data from the vehicle and to the remote station. The remote station analyzes the data to diagnose the cause of the plant malfunction and, if necessary, transmits additional diagnostic software agents to the vehicle to complete the diagnosis and then generates an output signal as a result of that analysis. If the malfunction is repairable at the plant, such as a software malfunction, the remote station transmits a software agent to the vehicle to perform the repair.

### BACKGROUND OF THE INVENTION

I. Field of the Invention

The present invention relates to a method and system for the remote diagnosis and repair of a plant malfunction.

II. Description of Related Art

Embedded systems in which a controller controls the operation of a plant in response to the output from one or more sensors associated with the plant are becoming increasingly prevalent in many types of machinery. For example, in the automotive industry, an electronic control unit, or ECU, is associated with the operation of the engine. The ECU receives various input signals representative of the operation of the engine as well as other components in the automotive vehicle. These sensors include, for example, fuel flow rate, throttle position, temperature, exhaust gas recirculation, mass air flow, etc.

In some cases, the ECU is also able to detect different types of engine and other types of malfunctions. Such malfunctions may include, for example, slow vehicle acceleration, cylinder misfire, etc.

Due to the relatively low computational power of these previously known ECUs in the vehicle plant, diagnosis of the cause of the plant or controller malfunction cannot be determined. Consequently, when such a malfunction was detected by the ECU, the ECU merely notified the vehicle driver of the existence of a problem, typically by illuminating an engine warning light in the vehicle. Once the engine warning light was illuminated, the driver of the vehicle would then take the vehicle to an automotive dealership for the full diagnosis and repair of the malfunction of the plant.

### SUMMARY OF THE PRESENT INVENTION

The present invention provides a method and system for remote diagnosis and, if possible, repair of the plant or controller in the automotive vehicle which overcomes the above-mentioned disadvantages of the previously known systems.

In brief, the method of the present invention, upon detecting a plant or controller malfunction (hereinafter collectively referred to as a plant malfunction), the vehicle controller transmits a diagnostic request to a remote station. The vehicle ECU may detect the malfunction and automatically transmit the diagnostic request to the remote station or, alternatively, the plant malfunction diagnostic request may be initiated by the vehicle driver.

After receipt of the diagnostic request by the remote station, the remote station selects a software agent (a computer program that acts for a user or other program in a relationship of agency) as a function of the nature of the malfunction and transmits a software agent from the remote station and to the plant. Furthermore, since the remote station typically has many times the computational power than the plant, the remote station is able to select and transmit the necessary software agent as a result not only of the diagnostic software contained at the remote station, but also a database of different types of plant malfunctions and suspected cause of the malfunction.

Upon receipt of the software agent at the plant, the controller executes the software agent to collect plant and/or controller data relative to the malfunction. After collecting the required data, the software agent transmits the collected data from the vehicle to the remote station.

The remote station then analyzes the collected data to diagnose the cause of the plant malfunction. In some cases, additional data may be required in which case the remote station transmits a different software agent designed to collect that additional data from the plant and the above process is repeated until the remote station is able to diagnose the cause of the plant malfunction.

After diagnosis of the plant malfunction, the remote station generates an output signal to the vehicle plant. In some cases where the plant malfunction is software based or may otherwise be repaired at the vehicle plant, the remote station transmits a repair software agent to fix the plant malfunction. In other cases, e.g. where the plant malfunction is hardware based, the remote station transmits an output signal advising the vehicle operator to bring the vehicle to a dealership for the appropriate repair. The remote station optionally schedules the delivery of the required parts necessary for the repair or otherwise determines that those necessary parts are available at the dealership.

A system to implement the above method is also disclosed.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a block diagrammatic view illustrating a preferred system of the present invention; and

FIG. 2 is an exemplary flowchart illustrating the operation of the system.

### DETAILED DESCRIPTION OF A PREFERRED EMBODIMENT OF THE PRESENT INVENTION

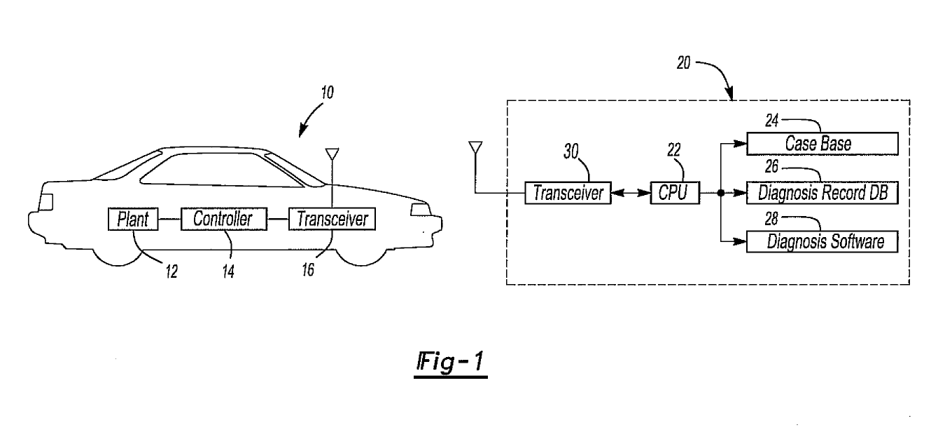

With reference first to FIG. 1, an automotive vehicle 10 is shown having a plant 12 which operates under the control of a controller 14. The controller 14 includes a processor or ECU which controls the operation of the plant 12 under software control in accordance with various sensors associated with the plant 12. These sensors include, for example, a throttle position sensor, fuel flow sensor, air flow sensor, exhaust gas recirculation sensor, etc. Furthermore, while the plant 12 includes the engine for the automotive vehicle 10, the plant may also include other systems associated with the vehicle 10.

A transceiver 16 is also contained in the vehicle 10. The controller 14 controls the operation of the transceiver 16 to both transmit as well as receive data.

Still referring to FIG. 1, a remote station 20 includes a processor 22 preferably having many times the computational power of the ECU associated with the plant controller 14 at the vehicle 10. The processor 22 also has access to various databases to diagnose and optionally repair malfunctions of the plant 12 and controller in the vehicle 10.

These databases include a case database 24 which contains data of the impact of different types of malfunctions of the vehicle plant 12 and the impact of those malfunctions on the various sensors associated with the plant 12.

The central processing unit 22 also includes diagnostic software 26 which, in cooperation with the case database 24, diagnoses the nature of the malfunction based upon the outputs from the various sensors associated with the plant 12. The processor 22 also accesses a diagnostic record database 28 in which the diagnostic record for each individual vehicle 10 is maintained.

The remote station 20 also includes a wireless transceiver 30. This wireless transceiver 30 is capable of both transmitting and receiving data to and from the transceiver 16 in the vehicle 10 and thus to and from the controller 14 in the vehicle 10.

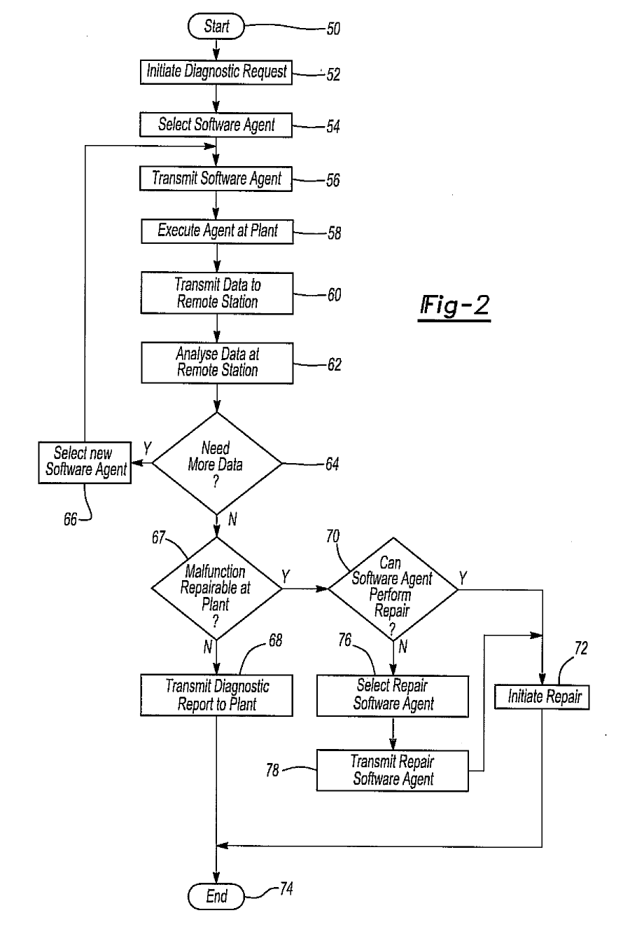

With reference now to FIG. 2, the operation of the system is illustrated. After initiation at step 50, step 50 proceeds to step 52 where a diagnostic request is initiated at the vehicle 10. The initiation of the diagnostic request at step 52 may be generated automatically by the controller 14 upon detection of the vehicle malfunction or, alternatively, may be initiated by the driver of the vehicle 10. In either case, upon the initiation of the diagnostic request at step 52, the controller 14 activates the receiver 16 to transmit the diagnostic request to the transceiver 30 at the remote station 20. Step 52 then proceeds to step 54.

At step 54, the processor 22 selects a software agent as a function of the nature of the malfunction identified in the diagnostic request. In doing so, the diagnostic software 26 at the remote station compares the diagnostic request with the case database 24 to determine the correct software agent Step 54 then proceeds to step 56.

At step 56, the remote station 20 transmits the selected software agent from the transceiver 30 and to the transceiver 16 at the vehicle 10. Step 56 then proceeds to step 58.

At step 58, the controller 14 executes the software agent at the vehicle 10. Upon execution, the software agent gathers data representative of values of various sensors associated with the plant 12. Furthermore, the execution of the software agent at step 58 may be done as a background program for the controller ECU or, alternatively, through the execution of a separate on-board processor. In any event, after the software agent gathers the data at step 58, step 58 proceeds to step 60.

At step 60, the data gathered by the software agent is transmitted by the transceiver 16 to the transceiver 30. Furthermore, the software agent may either collect all of the data and transmit all of the data following the conclusion of the data gathering by the software agent or, alternatively, may transmit the sensor data for the plant 12 in a piecemeal fashion as the individual sensor data are acquired by the software agent. In either event, after transmission of the acquired data by the software agent, step 60 proceeds to step 62.

At step 62, under control of the diagnostic software 26, the processor 22 analyzes the data collected by the software agent and compares that data to the case database 24 in an effort to identify the cause of the plant malfunction. Following this analysis, step 62 proceeds to step 64.

At step 64, the processor 22 determines whether or not additional sensor data from the plant 12 is required in order to fully identify the cause of the plant malfunction. If so, step 64 proceeds to step 66 where a new software agent is selected by the processor 22 to collect the additional required information. Step 66 then proceeds back to step 56 where the above process is reiterated until sufficient data has been acquired by the processor 22 to identify the cause of the plant malfunction or, alternatively, determine that it cannot identify the cause of the plant malfunction.

Conversely, if the processor 22 is able to identify the cause of the plant malfunction without the need for additional data, step 64 proceeds to step 67. At step 67, the processor 22 determines whether or not the malfunction is repairable at the plant 12 without the need to return the vehicle 10 to a repair facility. If the malfunction is not repairable at the plant, step 67 proceeds to step 68 where the remote station 20 transmits an output signal to the plant representative of either the cause of the plant malfunction or, alternatively, instructions for the driver of the vehicle. For example, step 68 may transmit a message to the vehicle driver instructing the vehicle driver to bring the car into a particular vehicle repair facility. Step 68 may also schedule the delivery of any required parts that may be required to perform the repair.

Conversely, if the plant malfunction is repairable at the plant, e.g. a software malfunction, step 67 instead proceeds to step 70 where the remote station 20 determines whether or not the software agent currently contained at the vehicle 10 is able to perform the required repair, e.g. a software patch. If so, step 70 proceeds to step 72 to initiate the repair at the vehicle 10. Step 72 then terminates the repair at step 74.

Conversely, if a different software agent is required at the vehicle 10 in order to perform the repair, step 70 instead branches to step 76 where the processor 22 at the remote station 20 selects the necessary software agent to perform the repair. Step 76 then proceeds to step 78 where the newly selected software agent is transmitted by the transceiver 30 to the vehicle transceiver 16. Step 78 then proceeds to step 72 and initiates the repair by execution of the software agent.

From the foregoing, it can be seen that the present invention provides a simple yet effective system and method for the remote repair of systems having a controller and a plant of the type used in automotive vehicles. Having described the invention, however, many modifications thereto will become apparent to those skilled in the art to which it pertains without deviation from the spirit of the invention as defined by the scope of the appended claims.

We claim:

1. A method for remote diagnosis of a plant malfunction from a remote station comprising the steps of:
a) sending a plant malfunction diagnostic request to the remote station,
b) transmitting a software agent selected as a function of the nature of the malfunction from the remote station to the plant,
c) executing the software agent to collect plant data relevant to the malfunction,
d) transmitting the collected data from the plant to the remote station,
e) analyzing the collected data at the remote station to diagnose the cause of the plant malfunction, and
f) generating an output signal as a result of said analysis.

2. The method as defined in claim 1 and reiterating steps b-e with different software agents until the cause of the malfunction is identified.

3. The method as defined in claim 1 wherein said output signal generating step comprises the step of transmitting a software agent from said remote station to said plant which, upon execution, repairs the malfunction if the malfunction comprises a software malfunction at the plant.

4. The method as defined in claim 1 wherein said sending step comprises the step of transmitting the plant malfunction request to the remote station upon detection of the malfunction by the plant.

5. The method as defined in claim 1 wherein said executing step comprises the step of execution the software agent as a background program of an electronic control unit for the plant.

6. The method as defined in claim 1 where the plant comprises a system for an automotive vehicle.

7. The method as defined in claim 1 wherein said output signal generating step comprises the steps of:
transmitting the diagnostic report to the plant,
receiving the diagnostic report at the plant, and
displaying the diagnostic report at the plant.

8. The method as defined in claim 1 wherein said output signal generating step comprises the steps of:
transmitting a repair software agent having repair software for the malfunction from the remote station to the plant,
executing the repair software agent at the remote station to effectuate the repair.

9. The method as defined in claim 1 wherein the software program is executed in an embedded system.

10. The method as defined in claim 1 wherein said step of sending a plant malfunction diagnostic request comprises the step of sending a maintenance request.

11. A system for remote diagnosis of a plant malfunction from a remote station comprising:
a) means for sending a plant malfunction diagnostic request to the remote station,
b) means for transmitting a software agent selected as a function of the nature of the malfunction from the remote station to the plant,
c) means for executing the software agent to collect plant data relevant to the malfunction,
d) means for transmitting the collected data from the plant to the remote station,
e) means for analyzing the collected data at the remote station to diagnose the cause of the plant malfunction, and
f) means for generating an output signal as a result of said analysis.

12. The system as defined in claim 1 wherein said means for transmitting the software agent comprises means for reiterating transmitting different software agents until the cause of the malfunction is identified.

13. The system as defined in claim 1 wherein said means for generating output signal comprises means for transmitting a software agent from said remote station to said plant which, upon execution, repairs the malfunction if the malfunction comprises a software malfunction at the plant.

14. The system as defined in claim 1 wherein said means for sending comprises means for transmitting the plant malfunction request to the remote station upon detection of the malfunction by the plant.

15. The system as defined in claim 1 wherein said means for executing comprises means for executing the software agent as a background program of an electronic control unit for the plant.

16. The system as defined in claim 1 where the plant comprises a system for an automotive vehicle.

17. The system as defined in claim 1 wherein said means for generating the output signal comprises:
means for transmitting the diagnostic report to the plant,
means for receiving the diagnostic report at the plant, and
means for displaying the diagnostic report at the plant.

18. The system as defined in claim 1 wherein said means for generating the output signal comprises:
means for transmitting a repair software agent having repair software for the malfunction from the remote station to the plant,
executing the repair software agent at the remote station to effectuate the repair.

19. The system as defined in claim 1 wherein the software program is executed in an embedded system.

20. The system as defined in claim 1 wherein said means for sending a plant malfunction diagnostic request comprises means for sending a maintenance request.
